(19) United States
(12) Patent Application Publication
(10) Pub. No.: US 2002/0016107 A1
(43) Pub. Date: Feb. 7, 2002

(54) Electrical connection assembly, particularly for local area networks

(76) Inventors: Yvan Bellemon, Reigner (FR); Pierre Sermondadaz, Annemasse (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/915,819

(22) Filed: Jul. 26, 2001

(30) Foreign Application Priority Data
Jul. 27, 2000 (FR) 00 09843

(51) Int. Cl. H01R 25/00; H01R 27/02; H01R 31/00; H01R 33/88; H01R 33/90; H01R 33/92; H01R 33/94; H01R 24/00

(52) U.S. Cl. 439/638; 439/676

(57) ABSTRACT

The present invention relates to an electrical connection assembly particularly for local area networks of high information bit rate, characterized in that it comprises: a socket (100) comprising electrical contacts (120) designed to be connected to the conductor of at least one connecting cable, while at the same time being accessible on the socket, and an insert (200) which can be fixed mechanically to the socket (100) and itself having electrical contacts (220) designed to come automatically to bear against the electrical contacts (120) of the socket (100) when the insert (200) is engaged therein, while at the same time themselves being accessible on the insert (200) in a selective layout tailored to the layout of a complementary connection assembly.

The present invention relates to the field of electrical connectors. It applies in particular to connectors for local area networks with high information bit rate.

At the beginning of the last decade, we have witnessed a significant increase in information bit rates on local area networks, seeing the corresponding base frequencies rise from 100 MHz in 1990 to 600 MHz in 1997, and even higher today.

This trend has created a strong demand for new cables and new types of connector associated with the needs of the market thus defined.

In practice these days, the person skilled in the art generally classifies connections for local area networks of high information bit rate under three broad headings.

The first and second headings cover connections operating at 100 MHz and 250 MHz respectively. These connections employ cables of four 100-ohm or even 120-ohm pairs, either without screen or with common screen using a metallized plastic tape twisted around the pairs. In certain cases, an earth drain is added. Finally, in the best of EMC circumstances, a braid is additionally arranged above the taped layer.

The third broad heading covers connections operating at 600 MHz (1 Gbit in the case of local area networks) and capable of rising to 1.3 GHz or more for multimedia applications. It uses cables of four 100-ohm or even 120-ohm pairs. These pairs have to be screened separately using metallized plastic tape. A common screen made up either of an additional tape or of a braid or, as appropriate, of a combination of such an additional tape and of a braid, covers the pairs.

One of the problems posed by the connecting devices proposed hitherto is that the broad range of connectors available nowadays means that, on site, it is frequently found that the connection assemblies (receptacle/plug) proposed and available are incompatible with each other.

The main objective of the present invention is to propose new connecting means making it possible to simplify connections, particularly for local area networks with high information bit rates.

This objective is achieved in the context of the present invention by virtue of a connection assembly comprising:

a socket comprising electrical contacts designed to be connected to the conductors of at least one connecting cable, while at the same time being accessible on the socket, and

an insert which can be fixed mechanically to the socket and itself having electrical contacts designed to come automatically to bear against the electrical contacts of the socket when the insert is engaged therein, while at the same time themselves being accessible on the insert in a selective layout tailored to the layout of a complementary connection assembly.

In the context of the present invention, there is thus provided a set of inserts having different layouts of their contacts, tailored respectively to the complementary connection assemblies.

According to another advantageous feature of the present invention, the socket carries at least one electrically conducting and elastic blade capable of providing an earth connection between a screen of the socket and a screen of the insert.

According to another advantageous feature of the present invention, either the socket or the insert carries at least one component such as a component capable of acting as a balanced-to-unbalanced transformer in respect of the signal.

Other features, objects and advantages of the present invention will become apparent on reading the detailed description which will follow, and upon studying the appended drawings, given by way of non-limiting examples, and in which:

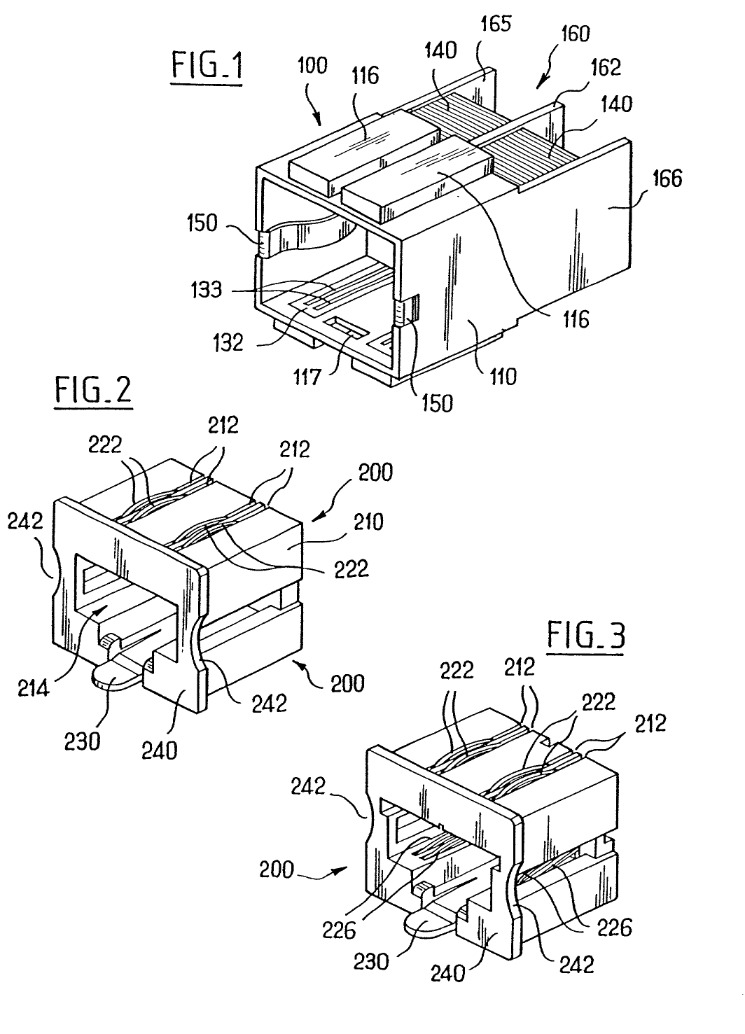

FIG. 1 depicts a schematic perspective view of a socket according to one preferred embodiment of the present invention,

FIGS. 2 and 3 depict perspective views of two inserts according to variants of the present invention,

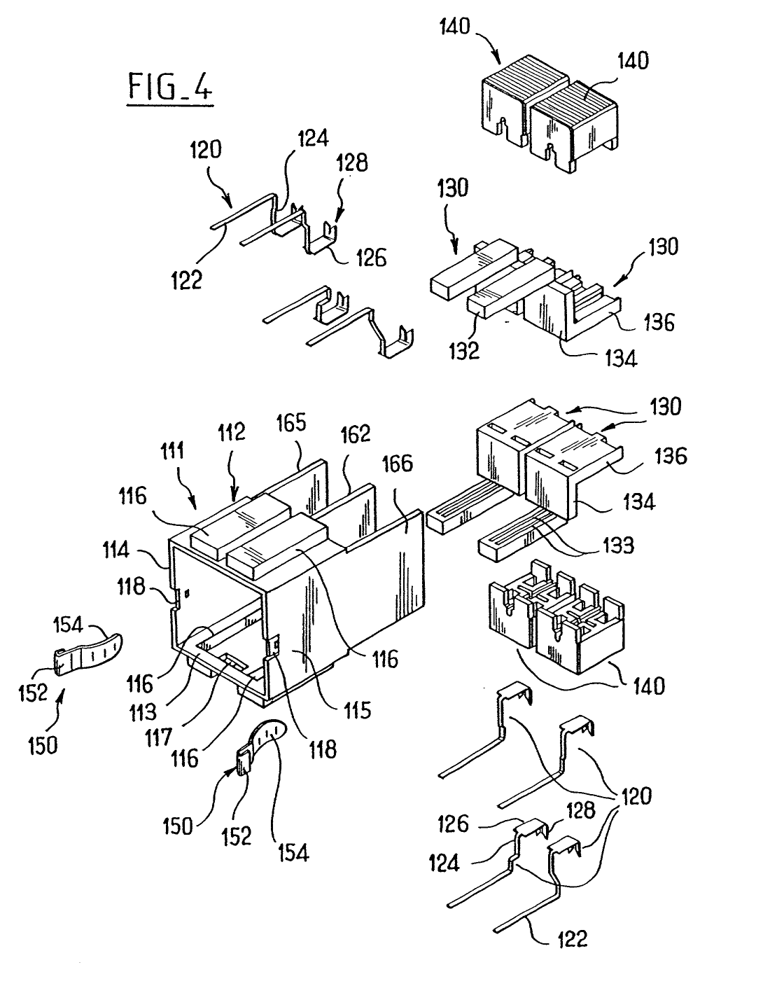

FIG. 4 depicts an exploded perspective schematic view of a socket according to the present invention,

FIG. 5 depicts a perspective rear view of the same socket,

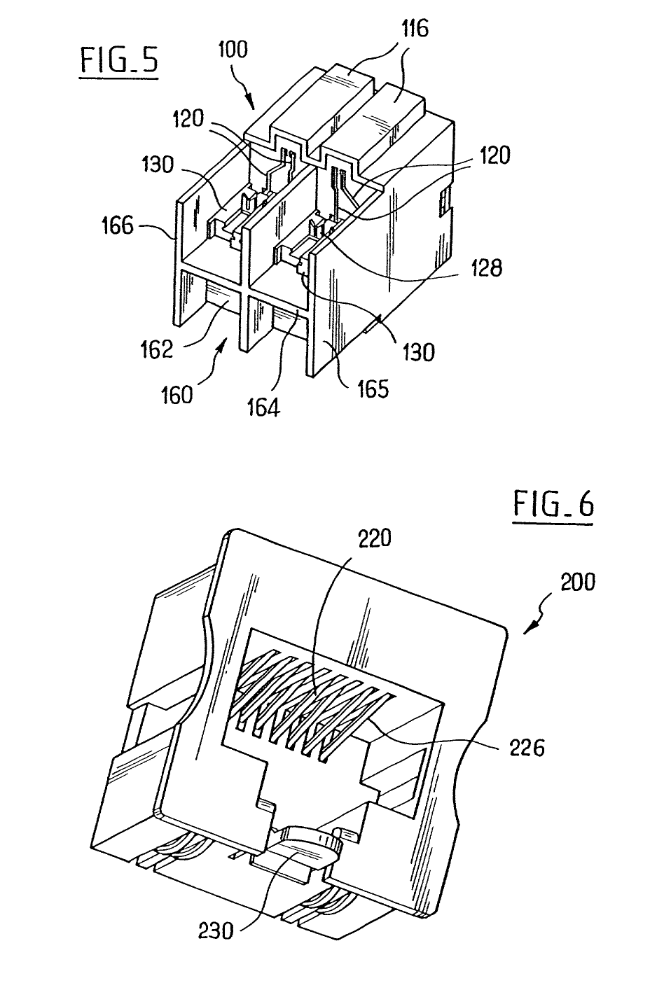

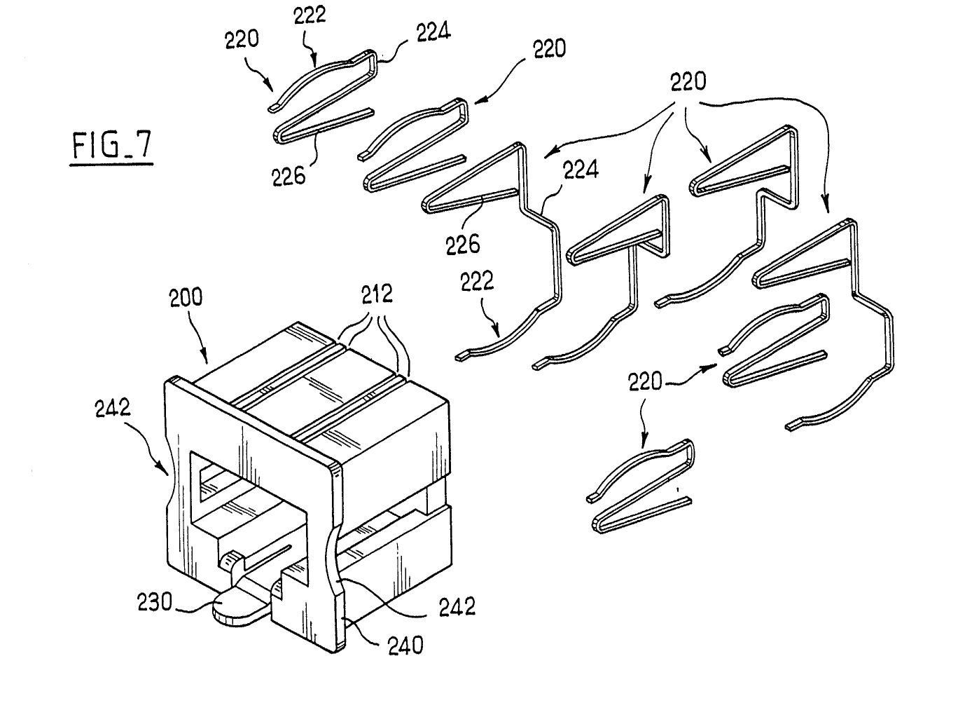

FIG. 6 depicts another perspective view of the insert according to the variant illustrated in FIG. 2,

FIG. 7 depicts an exploded perspective view of the same insert,

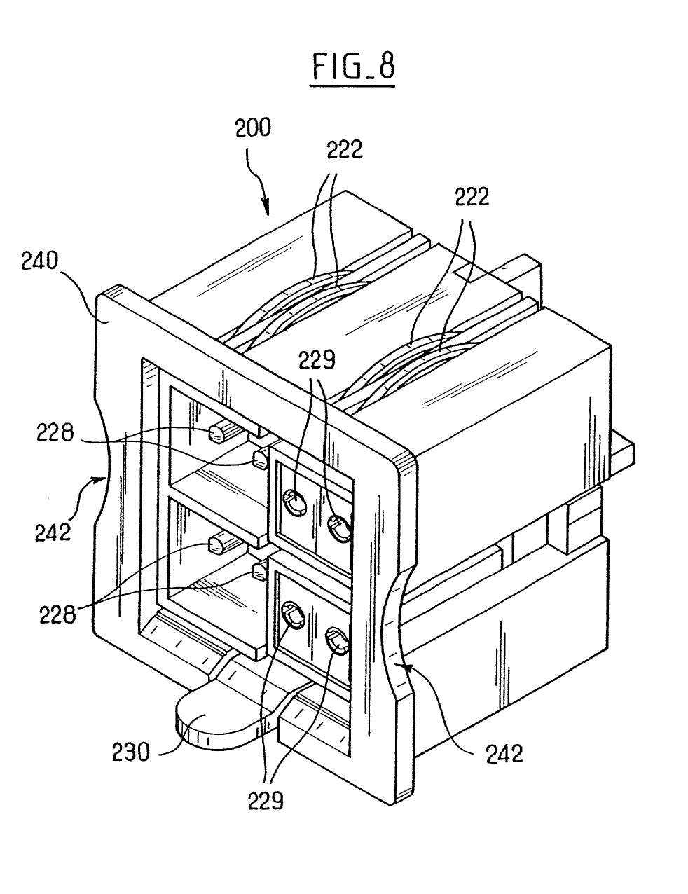

FIG. 8 depicts a perspective view of an insert according to a third variant of the present invention,

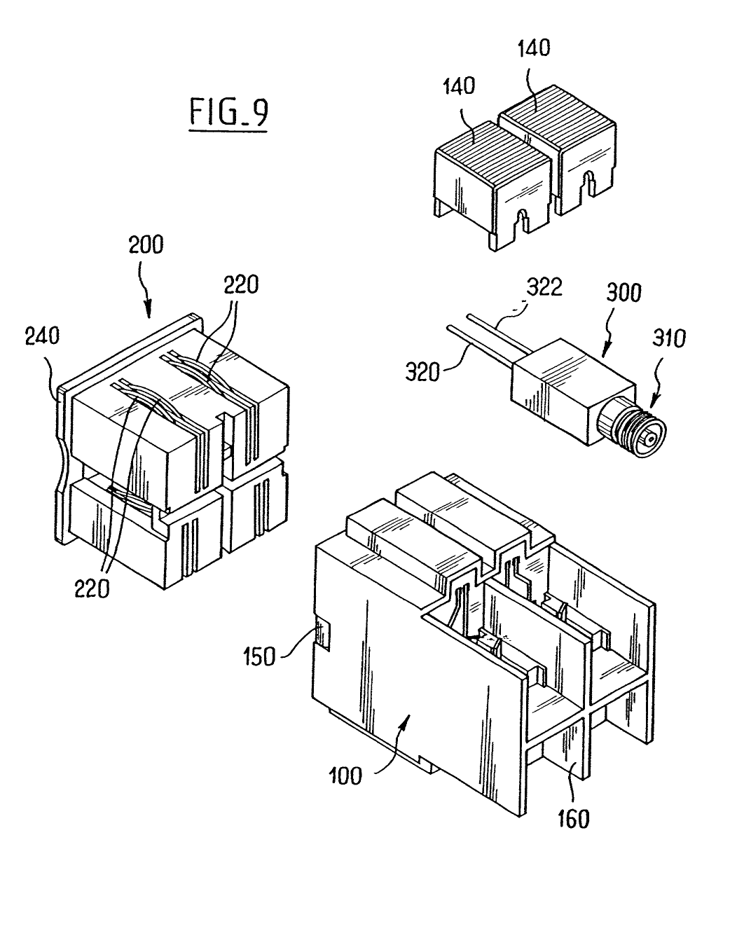

FIG. 9 depicts an exploded perspective view of an assembly comprising socket and insert according to a variant of the present invention, and

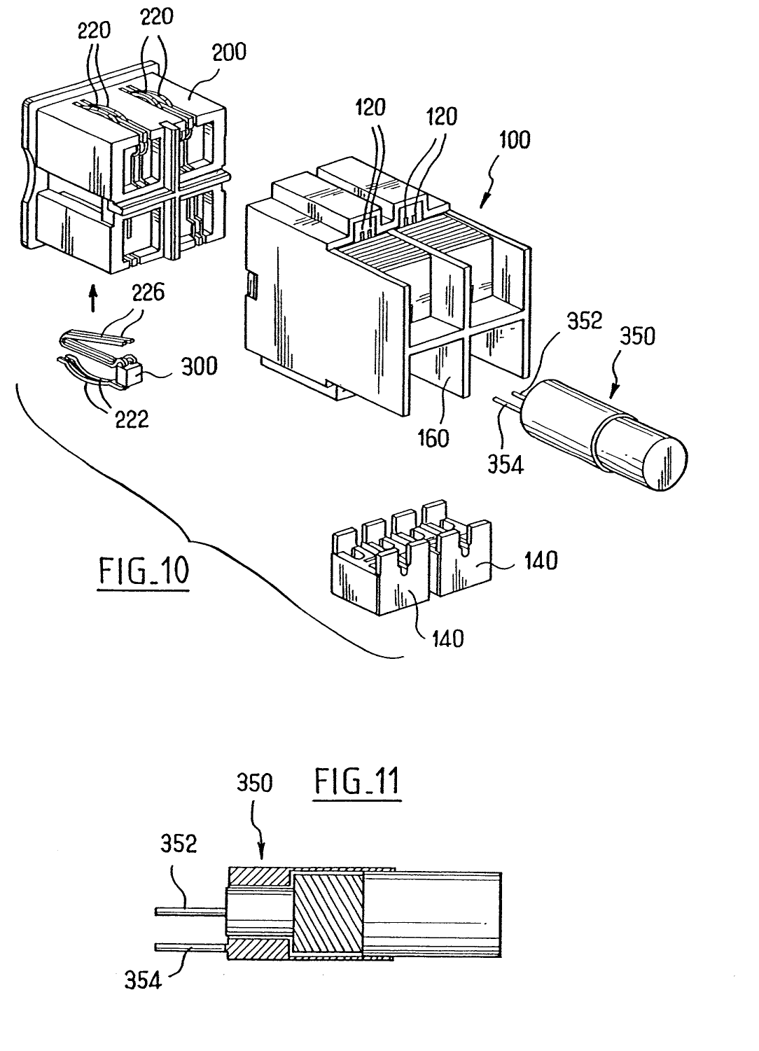

FIG. 10 depicts yet another variant of the assembly, while

FIG. 11 schematically depicts a view in longitudinal axial section of a adapter device capable of converting two parallel wires towards a coaxial plug.

The connection system according to the present invention and illustrated in the appended figures essentially comprises a socket 100 capable of selectively receiving an insert 200 chosen from a set of different available inserts.

FIG. 1 schematically illustrates a socket 100 according to one preferred embodiment of the present invention. The socket 100 is illustrated without its screen in FIG. 1.

The socket 100 comprises a body 110 of parallelepipedal overall shape. This body may be made of an electrically conducting material or alternatively may be made of a thermoplastic coated with an electrically conducting coating.

The socket 100 comprises a series of electrical contacts 120. These are designed to be connected to the conductors of at least one connecting cable, at the rear part of the socket 100, while at the same time being accessible on the socket 100, in the front part thereof.

More specifically, the contacts 120 are carried in pairs respectively by an insulating body 130 each associated with an inserter 140.

At the front part, the body 110 of the socket 100 has the form of a rectangular cage 111 formed of a top wall 112 and of a bottom wall 113 and of two side walls 114, 115. The two, top 112 and bottom 113, walls each define two parallel rectangular straight ducts 116 intended to receive the front part 132 of the insulators 130. In addition, the bottom wall 113 has near the opening contour of the socket 100 a housing 117 designed to accommodate complementary locking teeth provided on an insert 200.

Each of the two side walls 114, 115 defines a housing 118 capable of accommodating an elastic electrically conducting blade 150 capable of providing an electrical connection with the earth of the associated insert 200 so as to ensure screening continuity. Typically, each blade 150 comprises a clip 152 designed to be engaged over the front edge of a flank 114, 115 and which is extended backwards in the form of a corrugation 154 designed to come into contact with an insert 200.

The rear part of the socket 100, as can be seen in FIG. 5, preferably has the shape of a spider 160 forming a screen respectively between the four pairs of contacts. The spider 160 is made of two mutually perpendicular central membranes 162, 164. Furthermore, this screen is preferably, in the rear part of the socket 100, supplemented by two lateral flanks 165, 166 which respectively extend the two side walls 114, 115 of the front part.

According to the particular embodiment illustrated in the appended figures, the assembly is designed to receive four pairs of electrical contacts. However, the invention is not restricted to this particular layout.

As can be seen in FIG. 4, each electrical contact 120 is preferably formed of three portions:

a straight first portion 122 accessible at the front part 132 of an insulator 130 and at the front part 110 of the socket 100,

a second portion 124 forming a transition, capable of various configurations but on the whole perpendicular to the first portion 122, and

a third portion 126 which, on the whole, is parallel to the first portion 122, which extends towards the back of the socket 100 and ends in the form of a fork 128 with insulation cutter through collaboration with an inserter 140.

The geometry and the function of such insulation-cutting forks 128 which cut in collaboration with an inserter are known to those skilled in the art and so this layout will not be described further in detail hereinafter.

Each of the insulators 130 has a overall form which is the counterpart of contacts 120, that is to say that each insulator is preferably formed of three portions:

a front portion 132 in the overall form of a straight blade intended to take up its position in one of the grooves 116 in the front part of the socket, which first portion 132 itself defines two parallel grooves 133 each intended to accommodate a respective first portion 122 of a contact 120,

a second portion 134 on the whole perpendicular to the blade 132 and acting as a support for the transition portion 124 of the contacts, and

a third portion 136 on the whole parallel to the first portion 132, directed towards the rear of the socket 100 and acting as a support for the third portion 126 of the electrical contacts.

Thus, the eight contacts 120 are arranged in pairs in four insulators 130, at each corner respectively of the parallelepipedal cage 110.

The socket 100 is thus preferably permanently wired by virtue of the insulation-displacement contacts 128 with four pairs of cables, preferably separately screened.

Furthermore, as a preference, the rear part of the socket 100, receiving wiring via insulation-displacement contacts and inserter is mechanically and electromechanically closed by a conducting cap (not depicted in the appended figures in order to simplify the illustration), thus forming four tunnels each housing a pair of contacts, in collaboration with the aforementioned cruciform screen 160.

As already mentioned, in the context of the present invention, the socket 100 is capable selectively of receiving several types of inserts 200.

Three different types of insert have been depicted in the appended FIGS. 2, 3 and 8 respectively.

The insert illustrated in FIG. 2 is typically an insert of the RJ45 type, or alternatively of category 6, 5e or 5, according to the professional terminology adopted. The insert illustrated in FIG. 3 is typically an RJ45-compatible category 7 insert.

Each insert 200 is preferably formed of a block 210, generally parallelepipedal, the envelope of which complements the interior volume of the chamber defined by the front part 110 of the socket 100.

As a preference, the rear part of the insert 200 is fitted with a conducting cross which, on its face directed towards the socket 100, establishes an electromagnetically sealed contact with the cruciform part 160 of the socket through an arrangement of contacts which overlap chicane-style. Likewise, the face of the cross formed on the insert 200 directed towards the opening preferably has also an arrangement of contacts which overlap, chicane-style, and intended to ensure electromagnetic continuity with the screen of a plug intended to be coupled to the insert.

Each insert 200 also carried a set of electrical contacts 220.

Thus, as a preference, each insert 200 carries four pairs of electrical contacts 220.

These electrical contacts 220 are designed to come automatically to bear against the electrical contacts 120 of the socket 100 when an insert 200 is engaged thereon, while themselves being accessible on the insert 200. As already stated, the layout of the electrical contacts 220 on the insert 200 is tailored to the layout of the complementary plug or connection assembly.

As a preference, each of the electrical contacts 220 carried by an insert 200 has three portions:

a curved and elastic first end portion 222 arranged in an aperture 212 formed in the top wall or lower part of the insert 200 and emerging on the exterior face of these walls to come automatically into contact with the portion 122 of one of the contacts of the socket 100 when the insert 200 is engaged,

a transition portion 224 with various geometries depending on the connection configuration required on the insert 200, the second portion 224 however being transversal on the whole with respect to the first portion 222, and

a third portion 226 on the whole parallel to the first portion 222 and accessible inside a chamber 214 of the insert 200.

The portion 226 accessible inside the insert 200 is designed to come to bear against an associated electrical contact belonging to the complementary plug. This portion may be embodied in numerous ways. It will be noted that according to the particular embodiment illustrated in FIG. 7, the portion 226 is formed of an elastic clip with two branches in the form of a V.

Each insert 200 also has a locking tongue 230 having teeth designed to penetrate the housing 117 of the socket.

Each insert 200 also has, on the front face, a faceplate or flange 240 which, on its lateral edges, defines two curves 242 designed to make the insert 200 easier to grasp and to manipulate as it is engaged in a socket 100 and to withdraw from this socket.

As a preference, each insert 200 is made from a body of an electrically insulating material covered with an electrically conducting protective cap forming the earth.

As already indicated, the layout of the contacts 220 inside an insert can vary from one insert to another according to the connection configuration desired.

More specifically still, the position of the first portions 222 is preferably identical for all the inserts 200 so as to ensure correct connection with the socket 100. By contrast, the layout of the end portions 226 varies according to the configuration desired.

By way of non-limiting example, the insert depicted in FIG. 2 and illustrated furthermore in FIGS. 6 and 7 has a single plane of connection at the interior face of its top wall, on which all the portions 226 of the eight electrical contacts 220 are accessible, as can be seen in particular in FIG. 6.

By contrast, the insert illustrated in FIG. 3 has two planes of connection at the interior faces of, respectively, the top wall and the bottom wall of the insert, on each of which faces four end portions 226 of the contacts 220 are respectively available.

The shape of the contacts 120 and 220 carried by the socket 100 and the inserts 200 is advantageously designed to compensate for undesirable crosstalk effects.

FIG. 8 illustrates an embodiment variant of an insert also comprising four pairs of contacts 220 accessible on the top wall and the bottom wall in the form of portions comparable with the curved portion 222 described previously and accessible inside the insert in the form of two pairs of male pins 228 and two pairs of female pins 229. This arrangement is given merely by way of illustration and can also have numerous configurations and variants.

As suggested earlier, the connecting device according to the present invention can also carry at least one component, particularly an electrical or electronic signal-matching component.

In particular, in the context of the present invention, such a component may be formed of a signal balancing device which can be used, for example, for domestic teledistribution applications by cable or satellite. Such a balancing device is designed to convert a balanced signal between two wires available on a twisted pair into an unbalanced signal available on a coaxial cable between a central active wire and an earth or screen or, conversely, to convert an unbalanced signal into a balanced signal. Such a converter component makes it possible for example to have a coaxial output allowing a signal to be received from a video demultiplexer.

In practice, such a component is generally formed of a coupling transformer.

FIG. 9 schematically depicts such a component under the reference 300.

It can be seen that at the rear this component 300 has a compatible coaxial plug 310 supplying or receiving the unbalanced signal and, at the front has an output in the form of two parallel wires 320, 322 supplying or receiving the balanced signal. The distance between the axes of the two wires 320, 322 corresponds to the distance between the axes of two contacts 128 of the socket. Such a component 300 may be housed, for example, in the socket 100 at the rear part thereof as illustrated in FIG. 9.

Contact between the component 300 and the contacts 120 of the socket is ensured automatically by the insertion of the wires 320, 322 in the suitable insulation-displacement contacts 128.

By way of example, a video signal arriving on the coaxial cable and on the plug 310 is transformed by the component 300 into a balanced signal emerging on one of the four pairs of the socket 100. Quite obviously, within the context of the present invention, four balancing devices associated with a respective one of the contact pairs may be provided.

According to yet another variant illustrated in FIG. 10, the matching component 100 performing balanced-to-unbalanced conversion is no longer provided on the socket 100 but is provided selectively on each of the inserts 200. More specifically, according to the variant illustrated in FIG. 10, the component 300 is placed in a cavity in the rear part of an insert 200 between the two portions 222 and the two portions 226 of a pair of adjacent contacts 220.

In this case, the coaxial cable may be connected to the contacts 128 for example by placing the stripped core of the coaxial cable in an insulation-displacement contact 128 and by soldering an additional terminal wire, in engagement with the other insulation-displacement contact 128, onto the braid of the coaxial cable.

According to yet another variant as illustrated in FIGS. 10 and 11, this adaptation of the coaxial cable may be performed using a special-purpose component 350 designed to make a transition between two parallel wires 352, 354 at the spacing of a pair of contacts 128, on the one hand, and a coaxial output or input, on the other hand, on the other side.

1. Electrical connection assembly particularly for local area networks of high information bit rate, characterized in that it comprises:
a socket (100) comprising electrical contacts (120) designed to be connected to the conductors of at least one connecting cable, while at the same time being accessible on the socket, and
an insert (200) which can be fixed mechanically to the socket (100) and itself having electrical contacts (220) designed to come automatically to bear against the electrical contacts (120) of the socket (100) when the insert (200) is engaged therein, while at the same time themselves being accessible on the insert (200) in a selective layout tailored to the layout of a complementary connection assembly.

2. Assembly according to claim 1, characterized in that it comprises a set of inserts (200) respectively tailored to the complementary connection assembly through the layout of their electrical contacts (220).

3. Assembly according to one of claims 1 and 2, characterized in that the socket (100) carries at least one electrically conducting blade (150) capable of providing an earth connection between a screen of the socket (100) and a screen of the insert (200).

4. Assembly according to one of claims 1 to 3, characterized in that it further comprises a matching component.

5. Assembly according to claim 4, characterized in that the component is a balancing device (300).

6. Assembly according to one of claims 4 and 5, characterized in that the component (300) is placed on a socket (100).

7. Assembly according to one of claims 4 and 5, characterized in that the component (300) is placed on the insert (200).

8. Assembly according to one of claims 4, 5 and 7, characterized in that the component is placed between two portions of a pair of contacts (220) carried by the insert (200).

9. Assembly according to one of claims 1 to 8, characterized in that the socket (100) carries a screening spider (160).

10. Assembly according to one of claims 1 to 9, characterized in that it carries four pairs of electrical contacts (120, 220).

11. Assembly according to one of claims 1 to 10, characterized in that each contact (120) of the socket (100) has three portions: a first portion (122) designed to be accessible on the insert (200), a transition portion (124), and a third portion (126) designed for connecting to a cable.

12. Assembly according to claim 11, characterized in that the third portion (126) has an insulation-displacement contact (128).

13. Assembly according to one of claims 1 to 12, characterized in that the electrical contacts (120) of the socket (100) are carried in pairs by an insulating body (130).

14. Assembly according to one of claims 1 to 13, characterized in that an insert (200) has two planes of connection each in the form of two pairs of contacts (226).

15. Assembly according to one of claims 1 to 13, characterized in that an insert (200) has one plane of connection in the form of four pairs of electrical contacts (226).

16. Assembly according to one of claims 1 to 15, characterized in that each insert (200) has a screening spider.

17. Assembly according to one of claims 1 to 16, characterized in that each contact (220) of the insert has three portions: an elastic and curved first portion (222) designed to come to bear against a counterpart contact (122) belonging to the socket, a transitional intermediate portion (224), and an end portion (226), preferably elastic, accessible inside the insert to come into contact with a counterpart contact belonging to a complementary plug.
